(19) United States
(12) Patent Application Publication
(10) Pub. No.: US 2024/0279830 A1
(43) Pub. Date: Aug. 22, 2024

(54) PROCESS FOR CONTROLLING AN ELECTROLYZER

(71) Applicant: L'Air Liquide, Société Anonyme pour I'Etude et I'Exploitation des Procédés Georges Claude, Paris (FR)

(72) Inventors: Daniel SCHILD, Frankfurt am Main (DE); Jean-Philippe TADIELLO, Frankfurt am Main (DE); Frank CASTILLO-WELTER, Friedrichsdorf (DE)

(21) Appl. No.: 18/441,349

(22) Filed: Feb. 14, 2024

(30) Foreign Application Priority Data
Feb. 14, 2023 (EP) 23156642.3

(51) Int. Cl. C25B 15/025; C25B 1/04; C25B 9/77; C25B 15/08

(52) U.S. Cl. CPC C25B 15/025; C25B 1/04; C25B 9/77; C25B 15/087

(57) ABSTRACT

The invention relates to a process for controlling an electrolyzer. Determination of four different electrolyte flow rates at certain positions in the electrolyzer makes it possible to determine a compensation flow rate which establishes a fluidic connection between the anode side and the cathode side of the electrolyzer. The compensation system makes it possible to achieve at least partial concentration compensation between the electrolyte concentration on the anode side and the electrolyte concentration on the cathode side. The compensation flow rate makes it possible to draw conclusions about the operating state of the electrolyzer. The compensation flow rate makes it possible to determine a permeation flow rate between the anode space and the cathode space of one or more electrolysis cells. The permeation flow rate is correlated with a predetermined differential pressure between the anode space and the cathode space which improves the efficiency of the electrolyzer.

### CROSS REFERENCE TO RELATED APPLICATIONS

This application claims the benefit of priority under 35 U.S.C. § 119 (a) and (b) to European Patent Application No. 23156642.3, filed Feb. 14, 2023, the entire contents of which are incorporated herein by reference.

### BACKGROUND

### Technical Field of the Invention

The invention relates to a process for controlling an electrolyzer, in particular for controlling an alkaline electrolyzer for producing hydrogen.

### Prior Art

The electrolytic cleavage of water to produce hydrogen is increasingly gaining in importance in the present era of anthropogenic climate change. For the production of electrolytically produced hydrogen on a large industrial scale two processes in particular are of exceptional importance, namely proton exchange membrane (PEM) electrolysis and alkaline electrolysis.

In alkaline electrolysis the following half-cell reactions occur on the cathode side and the anode side.

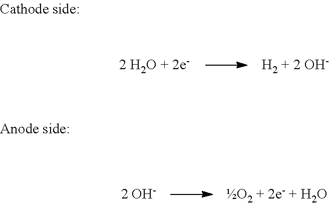

The net result is that one mole of water forms half a mole of molecular oxygen and one mole of molecular hydrogen. In order that the reactions can occur in the electrolysis half-cells, hydroxyl ions must diffuse through an ion-permeable separator which separates the cathode side and the anode side of the electrolysis cell. Especially in alkaline electrolysis such a separator is referred to as a diaphragm.

An electrolyzer on a large industrial scale comprises a multiplicity of electrolysis cells, wherein the individual cells are arranged one above the other in a stack and are combined in a frame. In this context it is thus customary to refer to an electrolysis cell stack or, for simplicity, a cell stack.

As is apparent from the abovementioned half-cell reactions, water is consumed on the cathode side while water is formed on the anode side. In alkaline electrolysis the electrolysis medium (electrolyte) is preferably a highly concentrated potassium hydroxide solution (aqueous KOH or KOH_{aq}). Due to the nature of the half-cell reactions occurring, consumption of water on the cathode side results in concentration of the electrolysis medium while formation of water on the anode side results in dilution of the electrolysis medium.

This is one of the reasons why alkaline electrolyzers are often operated in so-called cross flow mode. In this mode the cathode-side electrolysis medium (catholyte) and the anode-side electrolysis medium (anolyte) are mixed with one another after separation of the product gases (hydrogen and oxygen) in corresponding gas-liquid separators and subsequently separated back into two substreams and supplied to the respective sides (cathode space and anode space) of the electrolysis cell stack. The mixing effects a concentration compensation between the anolyte and the catholyte.

Alkaline electrolyzers are not necessarily run permanently under full load but rather must also be run at a lower current load from time to time, i.e. under partial load. This may be more necessary when using renewable energy sources when a lull in wind or lack of solar radiation means that less renewably generated electricity is available. Under partial load conditions a smaller gas amount per unit time is produced than when the electrolyzer is at full utilization. Accordingly, an equal diffusion amount of hydrogen to the anode side (“hydrogen to oxygen—HTO”), and vice versa of oxygen to the cathode side, results in considerably greater contamination of the produced gas amount under partial load. This can have the result that, due to accumulation of hydrogen on the oxygen side and vice versa, the lower explosive limit for occurrence of the oxyhydrogen reaction is exceeded, thus forming an explosive mixture. This must be avoided in all cases for safe operation of the electrolyzer.

For this reason alkaline electrolyzers at low current loads are preferably operated in a so-called parallel flow mode in which the above-described mixing of anolyte and catholyte is not carried out. However, due to the nature of the half-cell reactions, purely parallel flow operation leads over time to a continuous changing of the concentration of the electrolyte on the cathode side and on the anode side. Therefore, even in parallel flow mode an at least partial mixing of the anode-side electrolysis medium and the cathode-side electrolysis medium is required or at least advantageous. In this way the continuous concentration change over time may be at least partially compensated until a return to cross flow mode under full load is once again possible. To achieve this objective the electrolyzer may have a corresponding compensation system by which the required at least partial concentration compensation may be brought about by partial mixing of anolyte and catholyte.

In alkaline electrolyzers used today the current density (in A/cm²) acting in an electrolysis cell is relatively low compared to PEM cells. However, cells allowing higher current densities are already in development.

To achieve the highest possible efficiency of such a modern alkaline electrolysis cell it is necessary to establish a very precisely defined pressure difference between the cathode side and the anode side of the electrolysis cell or between the respective cathode spaces and the anode spaces of the electrolysis cell. The greater this pressure difference, the greater the motive force for the permeation of the hydroxyl ions through the separator (diaphragm) of the cell. Other motive forces for the permeation of the hydroxyl ions are the potential difference between the cathode and the anode and the concentration differences in the electrolyte solutions.

Increasing pressure difference between the cathode space and the anode space of an electrolyzer thus increases the efficiency of the electrolysis reaction since the hydroxyl ions are transported through the respective separator not only by diffusion forces but also by convection forces. On the other hand, the pressure acting on the diaphragm must not be excessive in order to prevent damage thereto. It is thus necessary to establish a highest possible pressure difference between the anode space and the cathode space while at the same time this differential pressure value must be controlled as precisely as possible in a very narrow range in order not to exceed a maximum permissible value.

A general disadvantage of an alkaline electrolyzer is the unknown permeation flow rate (permeation stream) through the diaphragm, knowledge of which would be useful in many respects. This depends on numerous process conditions of the electrolysis, but in particular on the pressure difference between the cathode space and the anode space of the cell stack. On the one hand the permeation stream can help to compensate concentration differences between the anode side and the cathode side. On the other hand the permeation stream also contributes to transporting dissolved gases through the diaphragm, thus leading to the abovementioned problems. It is therefore necessary to maintain the permeation stream through the diaphragm within a controlled and limited range.

Since the permeation stream should be maintained within a limited range and is difficult to control this is not a suitable manipulated variable for effecting concentration compensation between the anode side and the cathode side of the electrolysis medium. It is therefore preferable to realize the required concentration compensation via a compensation system which is arranged downstream of the gas-liquid separator and upstream of the cell stack and allows a compensation stream (also compensation flow rate) from the anode side of the electrolysis medium to the cathode side or vice versa allows a compensation stream from the cathode side to the anode side. It is important to know the compensation flow rate as precisely as possible since this is correlated with the permeation flow rate.

### SUMMARY

The permeation flow rate is not directly determinable using a flowmeter for example. Determining the compensation flow rate requires additional flowmeters, thus increasing the technical complexity of the electrolysis plant. Additional instrumentation is unwanted especially in the case of alkaline electrolyzers since the corrosive electrolysis medium necessitates particularly stable materials, for example pipe conduits and components made of nickel-based alloys. Additional flowmeters further result in additional pressure drops and, especially when arranged within the compensation system, lead to undesired pressure variations between the anode space and the cathode space of the cell stack. On the other hand, it is nevertheless desirable to know the compensation flow rate and the permeation flow rate as precisely as possible in order to draw conclusions about process behaviour. This makes it possible to improve the controllability of the electrolysis plant, in particular in respect of the pressure difference between the anode space and the cathode space and the resulting possible efficiency optimization and potentially problematic load on the diaphragm.

It is accordingly an object of the present invention to at least partially overcome the disadvantages of the prior art.

It is a further object of the present invention to provide a process which makes it possible to determine the compensation flow rate and further preferably the permeation flow rate without a need for additional instrumentation.

It is especially an object of the present invention to provide a process which makes it possible to determine the compensation flow rate and further preferably the permeation flow rate without additional flowmeters.

The independent claims make a contribution to the at least partial achievement of at least one of the above objects. The dependent claims provide preferred embodiments which contribute to the at least partial achievement of at least one of the objects. Preferred embodiments of constituents of one category according to the invention are, where relevant, likewise preferred for identically named or corresponding constituents of a respective other category according to the invention.

The terms “having”, “comprising” or “containing” etc. do not preclude the possible presence of further elements, ingredients etc. The indefinite article “a” does not preclude the possible presence of a plurality.

One aspect of the present invention proposes a process for controlling an electrolyzer, in particular for controlling an alkaline electrolyzer, for production of hydrogen, wherein the electrolyzer is operated with an electrolyte having an electrolyte concentration, wherein
the electrolyzer comprises an electrolysis cell stack having an anode space and a cathode space and
an anode-side and a cathode-side gas-liquid separator, wherein
the anode space and the anode-side gas-liquid separator are fluidically connected to one another via a first flow path and
the cathode space and the cathode-side gas-liquid separator are fluidically connected to one another via a second flow path and
the electrolyzer comprises a compensation system arranged downstream of the gas-liquid separator and upstream of the electrolysis cell stack which establishes a fluidic connection between the first and the second flow path and is configured such that an at least partial concentration compensation between an electrolyte concentration in the first flow path and an electrolyte concentration in the second flow path is achievable and wherein the process comprises the following process steps:
a) establishing a differential pressure Δp between the anode space and the cathode space;
b) determining
   i. a first electrolyte flow rate EF1 within the first flow path and upstream of the compensation system,
   ii. a second electrolyte flow rate EF2 within the second flow path and upstream of the compensation system,
   iii. a third electrolyte flow rate EF3 within the first flow path and downstream of the compensation system and
   iv. a fourth electrolyte flow rate EF4 within the second flow path and downstream of the compensation system;
c) determining a compensation flow rate CF from the abovementioned electrolyte flow rates, wherein the compensation flow rate CF corresponds to the net flow rate via the compensation system between the first flow path and the second flow path.

The process according to the invention is suitable for controlling, in particular for improving control of, an electrolyzer. The electrolyzer may be any type of electrolyzer which is operated with an electrolysis medium and has a measurable concentration of an electrolyte. The electrolyte is in particular a liquid solution of ions, especially comprising water as the solvent. The term “electrolyte concentration” then refers to the concentration of the dissolved substance or the dissolved ions. The electrolyte may therefore be for example an aqueous solution of a salt, an acid, a base, or combinations thereof. The “electrolyte” may also be referred to as the “electrolysis medium”.

The electrolyzer is preferably operated as an alkaline electrolyzer. The electrolyte is preferably an aqueous solution of a base, preferably an aqueous solution of an alkali metal hydroxide in water, for example an aqueous solution of sodium hydroxide, preferably an aqueous solution of potassium hydroxide. The concentration of alkali metal hydroxide in this solution may be up to 40% by weight. The electrolysis performed in the electrolyzer is preferably a water electrolysis to produce hydrogen as the primary target product and to produce oxygen as a further product.

The electrolyzer has a plurality of electrolysis cells arranged as electrolysis cell stacks, also known as cell stacks. Each of the electrolysis cells has an anode side and a cathode side, wherein the sides are separated from one another by a separator. The separator may be a membrane or a diaphragm. The separator is permeable for permeation of ions and in an alkaline electrolyzer especially for the permeation of hydroxyl ions. The entirety of the cathode sides of the electrolysis cells of the cell stack forms the cathode space and the entirety of the anode sides of the electrolysis cells of the cell stack forms the anode space.

The electrolysis cell stack is supplied with direct current from a direct current source, such as for example a rectifier. Supplying direct current to the electrolysis cell stack brings about product formation through electrochemical oxidation in the anode space and product formation through electrochemical reduction in the cathode space. The product is preferably a gaseous product. The product is formed through electrochemical reaction of a reactant from the electrolyte. The electrolyte preferably forms hydrogen in the cathode space and oxygen in the anode space. It is particularly preferable when a concentrated aqueous potassium hydroxide solution is used to produce hydrogen in the cathode space and oxygen in the anode space.

Separation of a gaseous product is carried out on the anode side in the anode-side gas-liquid separator, preferably separation of oxygen is carried out in the anode-side gas-liquid separator. To this end the gas-liquid separator is fluidically connected to the anode side of the electrolysis cell stack via a first flow path, for example via a conduit.

Separation of a further gaseous product is carried out on the cathode side in the cathode-side gas-liquid separator, preferably separation of hydrogen is carried out in the cathode-side gas-liquid separator. To this end the gas-liquid separator is fluidically connected to the cathode side of the electrolysis cell stack via a second flow path, for example via a conduit.

Biphasic mixture formed on the anode side in the electrolysis cell stack is withdrawn from the anode side of the electrolysis cell stack as biphasic anolyte and subsequently flows to the anode-side gas-liquid separator. Separation of the gaseous product formed on the anode side is effected therein. The gaseous product is preferably subjected to further workup. The anolyte largely freed of gaseous product is subsequently passed via the first flow path, for example a conduit, to the anode side of the electrolysis cell stack. Gaseous product, in particular oxygen, is again formed from the anolyte in the anode space of the electrolysis cell stack. The first flow path is thus configured for passing anolyte depleted in product gas from the anode-side gas-liquid separator to the anode space of the electrolysis cell stack.

Biphasic mixture formed on the cathode side in the electrolysis cell stack is withdrawn from the cathode side of the electrolysis cell stack as biphasic catholyte and subsequently flows to the cathode-side gas-liquid separator. Separation of the gaseous product formed on the cathode side is effected therein. The gaseous product is optionally subjected to further workup. The catholyte largely freed of gaseous product is subsequently passed via the second flow path, for example a conduit, to the cathode side of the electrolysis cell stack. Gaseous product, in particular hydrogen, is again formed from the catholyte in the cathode space of the electrolysis cell stack. The second flow path is thus configured for passing catholyte depleted in product gas from the cathode-side gas-liquid separator to the cathode space of the electrolysis cell stack.

The process according to the invention thus relates to an electrolyzer comprising a compensation system configured such that it is possible to achieve an at least partial concentration compensation between an electrolyte concentration in the first flow path and an electrolyte concentration in the second flow path. To be able to achieve concentration compensation between an anode-side electrolyte concentration and a cathode-side electrolyte concentration the compensation system comprises a fluidic connection between the first flow path and the second flow path which may be realized via one or more conduits for example. For example, if the electrolyzer is an alkaline electrolyzer and if this electrolyzer is operated in parallel flow mode concentration of the electrolyte occurs on the cathode side due to water consumption and dilution of the electrolyte occurs on the anode side due to formation of water. To achieve at least partial concentration compensation electrolyte could then flow from the first flow path on the anode side to the second flow path on the cathode side or vice versa via the compensation system.

This results in a compensation flow rate CF which corresponds to the net flow rate through the compensation system. In the case of a single flow rate when for example only one conduit between the first and the second flow path is present the net flow rate corresponds to the flow rate between the first and the second flow path.

The net flow rate may also be the sum of two or more flow rates which may all flow through the compensation system in the same flow direction (only from the anode side to the cathode side or only from the cathode side to the anode side) or in opposite directions (from the anode side to the cathode side and from the cathode side to the anode side). In the case of opposed flow directions of two or more flow rates, flow rates in one direction are given a positive prefix and the flow rate(s) in the opposite direction(s) are provided with a negative prefix. If for example a flow rate from the cathode side to the anode side is 100 kg/h and a flow rate from the anode side to the cathode side is 25 kg/h, the net flow rate is (100−25) kg/h, i.e. 75 kg/h.

Depending on the values of the electrolyte flow rates EF1 to EF4 the compensation flow rate CF can also assume a negative prefix.

The compensation flow rate CF may also be determined in the case where complete mixing of the anolyte and the catholyte is effected in cross flow mode. The compensation flow rate then corresponds for example to the difference in the electrolyte flow rates on the anode side and the cathode side upstream of the respective mixing apparatus when downstream of the mixing apparatus the electrolyte flow rates on the anode side and on the cathode side are identical. In this case the difference in the electrolyte flow rates upstream of the mixing apparatus is the net flow rate.

It has now been found that the compensation flow rate may be determined from measurement of the four electrolyte flow rates EF1, EF2, EF3 and EF4. The electrolyte flow rates EF1 and EF2 upstream of the compensation system are determined in the first (EF1) and second (EF2) flow paths respectively. The electrolyte flow rates EF3 and EF4 are determined downstream of the compensation system in the first (EF3) and second (EF4) flow paths respectively.

“Upstream of the compensation system” is in particular to be understood as meaning upstream of the compensation system and downstream of the gas-liquid separator. “Downstream of the compensation system” is in particular to be understood as meaning downstream of the compensation system and upstream of the electrolysis cell stack.

Determining the electrolyte flow rates EF1 to EF4 at the defined positions and the compensation flow rate derivable therefrom makes it possible to omit determination of the compensation flow rate using dedicated flowmeters, for example in a conduit connecting the first and second flow path.

Flow rates may be determined for example as volume flow (volume per unit time), mass flow (mass per unit time) or amount of substance flow (amount of substance, for example kmol, per unit time). Flow rates may be determined industrially using a flowmeter for example.

A differential pressure Δp is established between the anode space and the cathode space to improve the efficiency of the electrolyzer over this step of the control process. Establishing a differential pressure Δp improves transport of ions through the separators of the electrolysis cells. In one example the differential pressure is in a range from 2 to 100 mbar, preferably in a range from 5 to 75 mbar, more preferably in a range from 10 to 60 mbar.

It has further been found that

$$CF = EF 3 - EF 1 and$$

$$CF = EF 2 - EF 4.$$

This means that the compensation flow rate CF may be determined by calculating the difference between the third and the first electrolyte stream and/or the difference between the second and the fourth electrolyte stream.

A preferred embodiment of the process according to the invention is characterized in that the process comprises the further process steps:
d) determining a feed flow rate FF, wherein the feed flow rate FF corresponds to the amount of water supplied to the electrolyzer per unit time and consumed per unit time by a hydrogen formation reaction and an oxygen formation reaction;
e) determining a permeation flow rate PF from the feed flow rate FF and the compensation flow rate CF, wherein the permeation flow rate PF corresponds to the flow rate through all separators arranged between the cathode space and the anode space.

The electrolyzer is preferably used to perform a water electrolysis to produce hydrogen and oxygen. The amount of water consumed for electrolytic formation of hydrogen and oxygen requires continuous replacement. In one embodiment the electrolyzer is thus permanently supplied with water at a feed flow rate FF during ongoing operation. The water is supplied for example via a water tank, preferably via one of the gas-liquid separators. The feed flow rate FF required to replace the consumed water may be determined indirectly by means of the current load applied to the electrolysis cell stack for example.

The permeation flow rate PF corresponds to the flow rate through all separators arranged between the cathode space and the anode space. In other words the permeation flow rate PF corresponds to the flow rate in the electrolysis cell stack from the cathode side to the anode side through the corresponding separators of the electrolysis cells or the flow rate in the electrolysis cell stack from the anode side to the cathode side through the corresponding separators of the electrolysis cells. The direction of the permeation flow is determined by the differential pressure Δp between the anode space and the cathode space according to whether the absolute pressure is greater in the cathode space or in the anode space. Broken down to the level of an individual cell, the permeation flow rate may differ slightly from cell to cell. Even if these individual partial permeation flow rates cannot be reliably determined it may be assumed that the arithmetic average of these partial permeation flow rates multiplied by the number of cells corresponds to the permeation flow rate PF.

It has been found that a permeation flow rate PF may be determined from the determined feed flow rate FF and the compensation flow rate CF determined from the electrolyte flow rates EF1 to EF4. This especially utilizes the finding that the feed flow rate FF corresponds to the amount of water which, in the case of an alkaline electrolysis, corresponds to the amount of water formed at the anode according to the anodic half-cell reaction

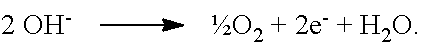

The sum of this “anodic flow rate” corresponds to the feed flow rate FF if it is assumed that only minor water losses, if any, occur with the discharging of the gaseous products from the electrolyzer, as is the case in practice as a result of appropriate measures, for example condensation and recycling of process water.

It has accordingly been found that upon equating the feed flow rate FF to the “anodic flow rate”

$$PF = CF + FF .$$

The permeation flow rate may therefore be particularly easily determined if the compensation flow rate CF is known due to the determined electrolyte flow rates EF1 to EF4.

The permeation flow rate is determinable via appropriate instrumentation only with great difficulty and imprecision, if at all. Determination and knowledge of the permeation flow rate using the compensation flow rate CF and the feed flow rate FF represents an opportunity to significantly improve control of the electrolyzer.

Determination of the compensation flow rate CF and the permeation flow rate PF from the abovementioned electrolyte flow rates EF1 to EF4 and the feed flow rate FF entails the following advantages for controlling an electrolyzer.

The determined compensation flow rate CF may be used as an indicator for a great many scenarios problematic to safety in which a hazardous explosive mixture of hydrogen and oxygen is formed in one of the gas-liquid separators in particular. Such a scenario may be triggered for example through failure of one of the electrolyte pumps in the first or second flow path or their control loops or through malfunctioning or improper adjustment of a shutoff valve in the compensation system. In such a case the compensation flow rate CF would change in such a way that this change may be considered an indicator of a malfunction.

Determination of the permeation flow rate PF based on the compensation flow rate CF and the feed flow rate FF entails the following advantages for control of the electrolyzer.

The permeation flow rate PF may be utilized as a characteristic operating parameter for the electrolysis cell stack since there is a correlation between the permeation flow rate and the differential pressure between the cathode space and the anode space. Knowledge of the permeation flow rate may also be utilized to configure the separator between the anode space and the cathode space.

The permeation flow rate PF is moreover useful for improving efficiency through adaptation of the process parameters according to the permeation through the separator between the anode space and the cathode space. This applies especially to electrolyzers with integrated control logic for the differential pressure Δp between the anode space and the cathode space.

Determining the permeation flow rate PF is further suitable for improving the operability of the plant in question. This is because understanding of current plant status is significantly improved when all liquid streams relevant to the electrolyte are known.

Knowledge of the permeation flow rate PF is moreover a value relevant to plant safety for long-term operation of the electrolyzer since a drifting permeation flow rate PF is an early sign of ageing and ultimately failure of a separator (for example a diaphragm or membrane) between an anode space and a cathode space. The permeation flow rate is also a safety-relevant value with respect to shorter periods since a permeation flow rate PF that is higher than expected may be a sign of failure of a separator. There are different causes for such a failure, for example a crack or fracture due to mechanical damage or a failure of the differential pressure control means between the anode space and the cathode space if such a means is integrated.

One embodiment of the process according to the invention is characterized in that the third electrolyte flow rate EF3 and the fourth electrolyte flow rate EF4 are adjusted such that

$$EF 3 = EF 4.$$

In other words in this embodiment the electrolyte flow rates within the first flow path and the second flow path downstream of the compensation system are adjusted such that they are equal. “Equal” is especially to be understood as meaning that their target value is equal within a defined error tolerance and preferably also that their actual value is equal within a defined error tolerance. The electrolyte flow rates EF3 and EF4 may be adjusted as a volume flow, mass flow or amount of substance flow for example. This measure ensures that the anode side and the cathode side of the electrolysis cell stack are uniformly fed. This reduces the mechanical load on the electrolysis cells, in particular the separators. In addition, heat of reaction formed in the electrolysis cells may be better removed since the heat transfer is more uniform on account of the identical electrolyte flow rates.

One embodiment of the process according to the invention is characterized in that the liquid level in each of the gas-liquid separators is controlled such that it assumes a constant value over time.

In this embodiment each of the gas-liquid separators has a fill level target value with a predefined maximum deviation. It is preferable when the fill level in each of the separators is adjusted such that it is as equal as possible. However, the fill level in the cathode-side and the anode-side separator will differ slightly on account of the differential pressure Δp established and in proportion therewith.

One embodiment of the process according to the invention is characterized in that the differential pressure Δp is adjusted according to the utilization of the electrolyzer, in particular according to the current load applied to the electrolysis cell stack.

The motive force in every electrolysis process is inter alia the migration of ions between the anode space and the cathode space. In the case of an alkaline electrolysis, hydroxyl ions (OH⁻) must migrate from the cathode space through the separator into the anode space in order that both half-cell reactions can proceed. The migration of the ions has a diffusive proportion and with increasing pressure difference between the anode space and the cathode space advantageously an increasing convective proportion. At low load, i.e. relatively low current densities, the electrolyzer is preferably run in parallel flow operation since the diffusion and/or convection of hydrogen to the oxygen side (and vice versa) takes effect particularly at low loads. Accordingly, in this low-load operation Δp should not be set excessively high in order not to promote this undesired process on account of safety-relevant aspects.

One embodiment of the process according to the invention is characterized in that the electrolyzer is operated in parallel flow mode, wherein electrolyte withdrawn from the anode-side gas-liquid separator is supplied to the anode space and electrolyte withdrawn from the cathode-side gas-liquid separator is supplied to the cathode space and wherein the compensation system at least partially effects concentration compensation between the electrolyte concentration in the first flow path and the electrolyte concentration in the second flow path.

In the context of the present disclosure “parallel flow mode” is to be understood as meaning that no complete mixing, in particular only a small extent of partial mixing of the anode-side and the cathode-side electrolyte, is carried out. It is preferable when only anode-side or only cathode-side mixing is effected through anolyte flowing onto the cathode side or vice versa catholyte flowing onto the anode side. As a result in particular either anolyte or catholyte unchanged after withdrawal from the gas-liquid separator is supplied to the anode side or cathode side of the electrolysis cell stack. The compensation system at least partially brings about a concentration compensation between the electrolyte concentration in the first flow path and the electrolyte concentration in the second flow path, in particular the compensation system partially brings about a concentration compensation between the electrolyte concentration in the first flow path and the electrolyte concentration in the second flow path.

One embodiment of the process according to the invention is characterized in that the electrolyzer is operated in cross flow mode, wherein the electrolyte withdrawn from the anode-side gas-liquid separator and the electrolyte withdrawn from the cathode-side gas-liquid separator are completely mixed and subsequently the resulting mixed electrolyte stream is separated into two substreams and the substreams are supplied to the cathode space and the anode space.

This cross flow operation in principle effects concentration compensation between the electrolyte on the anode side and on the cathode side. In particular this concentration compensation is effected entirely through the mixing of the anolyte and catholyte and so in each case identical concentrations of electrolyte prevail on the anode side and on the cathode side. The differential pressure Δp between the anode space and the cathode space has the result that the permeation flow rate PF is non-zero. Accordingly, for mass balance compensation between the anode side and the cathode side a non-zero compensation flow rate CF via the compensation system is regularly necessary so that in cross flow operation too the net flow rate through the compensation system is regularly non-zero.

One embodiment of the process according to the invention is characterized in that the compensation system
comprises a third flow path which effects fluidic connection of the first flow path and the second flow path to one another, wherein the third flow path is arranged downstream of the positions at which determination of the first electrolyte flow rate EF1 within the first flow path and determination of the second electrolyte flow rate EF2 within the second flow path are effected and
comprises a fourth flow path which effects fluidic connection of the first flow path and the second flow path to one another, wherein the fourth flow path is arranged downstream of the third flow path and upstream of the positions at which determination of the third electrolyte flow rate EF3 within the first flow path and determination of the fourth electrolyte flow rate EF4 within the second flow path are effected.

One arrangement according to the abovementioned embodiment allows operation of an electrolyzer with simple interconnection of the required conduits both in parallel flow operation and in cross flow operation. In both operating modes a compensation flow rate via the third and/or fourth flow path is realizable. It is preferable when the third flow path is closed in parallel flow operation and the compensation flow rate CF is realized along the open fourth flow path. It is preferable when the third flow path is open in cross flow operation and the compensation flow rate CF is realized along the likewise open fourth flow path.

This is preferably realized by arranging a first valve within the third flow path and arranging a second valve within the fourth flow path and arranging a third valve within the first flow path or within the second flow path downstream of the third flow path and upstream of the fourth flow path.

The valves may in particular be control valves but depending on the requirements simple switching valves which either fully open or fully close the respective flow path, for example the cross section of a conduit, may also be sufficient.

One embodiment of the process according to the invention is characterized in that a first electrolyte circulation pump is arranged within the first flow path and a second electrolyte circulation pump is arranged within the second flow path.

This embodiment is preferred in particular for the above configuration with the third and fourth flow path.

One embodiment of the process according to the invention is characterized in that the compensation system is characterized in that the first flow path and the second flow path are configured as a common flow path along a flow path section, wherein the flow path section is arranged downstream of the positions at which determination of the first electrolyte flow rate EF1 within the first flow path and determination of the second electrolyte flow rate EF2 within the second flow path are effected and the flow path section is arranged upstream of the positions at which determination of the third electrolyte flow rate EF3 within the first flow path and determination of the fourth electrolyte flow rate EF4 within the second flow path are effected.

In this embodiment the electrolyzer may be operated exclusively in cross flow operation since the combining of the first flow path and the second flow path as a common flow path along a flow path section, for example as an individual conduit along a flow path section, necessarily effects complete mixing of the anode-side electrolyte and the cathode-side electrolyte. The compensation flow rate CF then corresponds, for example, to the difference between the flow rate in the first flow path upstream of the common flow path and the flow rate in the second flow path upstream of the common flow path if the flow rates in the first and the second flow path downstream of the common flow path are identical.

It is preferable when an electrolyte circulation pump is arranged within the flow path section.

In this configuration the electrolyzer may be operated with only a single electrolyte circulation pump.

The electrolyzer is operated for example at a pressure of 5 to 40 bar (absolute), preferably at a pressure of 10 to 30 bar. The electrolyzer is further operated at a temperature of 40° ° C. to 120° C., preferably at a temperature of 50° C. to 100° C. These are especially the prevailing temperatures at the outlet of the electrolysis cell stack.

### BRIEF DESCRIPTION OF THE FIGURES

The invention is more particularly elucidated hereinbelow by exemplary embodiments. In the following detailed description, reference is made to the attached drawings, which show specific embodiments of the invention by way of illustration. The following detailed description is not to be understood in a limiting sense, and the scope of protection of the embodiments is defined by the accompanying claims. Unless otherwise stated, the drawings are not true to scale.

In the figures

FIG. 1 is a schematic representation of a first embodiment of an electrolysis assembly configured for performing the process according to the invention in parallel flow mode,

FIG. 2 is a schematic representation of the electrolysis assembly according to FIG. 1 for performing the process according to the invention in cross flow mode,

FIG. 3 is a schematic representation of a second embodiment of an electrolysis assembly configured for performing the process according to the invention.

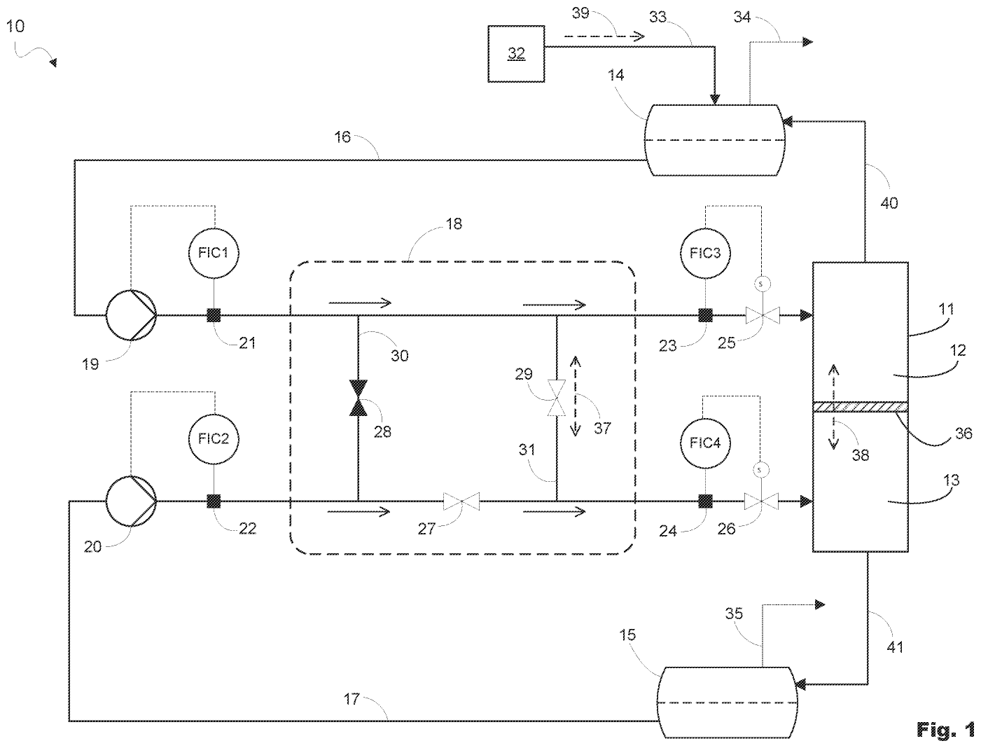

In FIGS. 1 to 3 identical elements are each provided with identical reference numerals.

In the context of the invention an “electrolyzer” is to be understood as meaning an electrolysis assembly which in a technical sense need not necessarily contain exclusively the electrolyzer as such. On the contrary, balance of stack or balance of plant components such as for example a gas-liquid separator or circulation pumps are also considered part of the electrolyzer. In the context of the present disclosure the technical terms “electrolyzer” and “electrolysis assembly” are thus considered synonymous.

### DETAILED DESCRIPTION OF PREFERRED EMBODIMENTS

In FIGS. 1 to 3, flow directions of the electrolytes are indicated by unlabeled arrows.

FIG. 1 shows a schematic and greatly simplified representation of a first embodiment of an electrolysis assembly 10 suitable for performing the process according to the invention and for performing the process in parallel flow mode.

The electrolysis assembly according to FIG. 1 comprises an electrolysis cell stack 11 which for the sake of simplicity is shown as a single electrolysis cell having an anode space 12 and a cathode space 13 and a separator 36 (diaphragm). The electrolysis assembly is configured for performing an alkaline electrolysis with concentrated aqueous potassium hydroxide solution (KOH_{aq}) as the electrolysis medium. Electrochemical reaction is made possible by supplying the electrode cell stack 11 with direct current (not shown), preferably from a renewable energy source. In the anode space water electrolysis produces oxygen while hydrogen is produced in the cathode space. The biphasic mixture of electrolysis medium and oxygen formed in the anode space is passed into an anode-side gas-liquid separator 14 via a first connecting conduit 40. The gas-liquid separator 14 effects separation of the gaseous anode product (oxygen) which is discharged from the process via an oxygen product conduit 34. Further process steps for workup of the anode product (drying, removal of residual hydrogen) are not shown.

Analogously to the above, hydrogen is produced in cathode space 13 and the corresponding biphasic mixture of electrolysis medium and hydrogen is passed to a cathode-side gas-liquid separator 15 via a second connecting conduit 41. The separated hydrogen is discharged from the process via a hydrogen product conduit 35. Further process steps for workup of the cathode product (drying, removal of residual oxygen) are not shown.

The oxygen-depleted electrolysis medium, also known as anolyte, is recycled to the anode space 12 of the electrolysis cell stack 11 via a first flow path 16, for example a conduit. The biphasic mixture in conduit 40 and the oxygen-depleted electrolysis medium in the first flow path 16 are recirculated using an electrolyte circulation pump 19. In the flow path 16 an electrolyte flow rate EF1 is determined using a flowmeter 21. The flowmeter 21 is in operative connection with a flow controller FIC1 which controls the flow rate EF1 at this point via the electrolyte circulation pump 19. Also arranged in the flow path 16 is a further flowmeter 23 for determining an electrolyte flow rate EF3. The flowmeter 23 is in operative connection with a flow controller FIC3 which controls the electrolyte flow rate EF3 at this point via a control valve 25.

The hydrogen-depleted electrolysis medium, also known as catholyte, is recycled to the cathode space 13 of the electrolysis cell stack 11 via a second flow path 17, for example a conduit. The biphasic mixture in conduit 41 and the hydrogen-depleted electrolysis medium in the second flow path 17 are recirculated using an electrolyte circulation pump 20. In the flow path 17 an electrolyte flow rate EF2 is determined using a flowmeter 22. The flowmeter 22 is in operative connection with a flow controller FIC2 which controls the electrolyte flow rate EF2 at this point via the electrolyte circulation pump 20. Also arranged in the second flow path 17 is a flowmeter 24 for determining an electrolyte flow rate EF4. The flowmeter 24 is in operative connection with a flow controller FIC4 which controls the electrolyte flow rate EF4 at this point via a control valve 26.

A pressure control system (not shown) is used to establish a differential pressure Δp between the anode space 12 and the cathode space 13 to improve the transport of hydroxyl ions through the separator 36 (diaphragm) as one of the motive forces of the electrolysis process. Especially on account of this differential pressure Δp a permeation flow 38 having a permeation flow rate PF through the separator 36 is effected. The direction of this permeation flow 38 depends on the corresponding pressure conditions. If for example the absolute pressure in the anode space 12 is higher than in the cathode space 13 then the net result is that more electrolyte flows from the anode space through the separator into the cathode space than vice versa.

The electrolysis assembly 10 further comprises a compensation system 18 which is arranged downstream of the flowmeters 21 and 22 and upstream of the flowmeters 23 and 24. The compensation system 18 comprises a third flow path 30, for example a conduit. The third flow path 30 establishes a fluidic connection between the first flow path 16 and the second flow path 17. A switching valve 28 which can either fully open or fully close the flow path 30 is arranged within the third flow path 30. In the case of the electrolysis assembly 10 according to the configuration of FIG. 1 the switching valve 28 is closed (indicated by black shading). A fourth flow path 31 is arranged downstream of the third flow path 30. The fourth flow path 31 establishes a fluidic connection between the first flow path 16 and the second flow path 17. The fourth flow path 31 is arranged downstream of the third flow path 30 and upstream of the flowmeters 23 and 24 and the electrolysis cell stack 11. A switching valve 29 which either fully opens or fully closes the fourth flow path 31 is arranged within the fourth flow path 31.

An open switching valve 29 allows flow through the fourth flow path 31 which at least partially allows concentration compensation in respect of the concentration of KOH in the electrolytes in the first flow path 16 and in the second flow path 17. The electrolysis assembly 10 according to FIG. 1 is operated in parallel flow mode as shown here. Since the switching valve 28 is closed no mixing between the anolyte in the first flow path 16 and the catholyte in the second flow path 17 initially occurs. If the switching valve 29 is likewise closed, no mass transfer between the first flow path 16 and the second flow path 17 can occur. This would constitute complete operation in parallel flow mode. Consequently the concentration of dissolved KOH in the anolyte would continuously fall (formation of water on the anode side) and of dissolved KOH in the catholyte would continuously rise (consumption of water on the cathode side). To compensate for this a flow through the fourth flow path may be induced by opening the switching valve 29. This makes it possible to achieve at least partial concentration compensation between the anode side and the cathode side. To achieve this the electrolyte flow rates EF1 at flowmeter 21 and EF2 at flowmeter 22, for example, may be controlled such that they have different magnitudes. Simultaneously for example the electrolyte flow rates EF3 at flowmeter 23 and EF4 at flowmeter 24 may be identical through corresponding control. Such control necessarily results in a corresponding compensation flow 37 through the fourth flow path 31 and thus a corresponding concentration compensation. The resulting compensation flow rate CF is thus derived from the electrolyte flow rates EF1 to EF4. The flow through the fourth flow path 31 may occur from the first flow path 16 in the direction of the second flow path 17 or vice versa depending on the magnitude of the electrolyte flow rates EF1 to EF4. If for example the electrolyte flow rates EF3 and EF4 are equal and the electrolyte flow rate EF1 is greater than the electrolyte flow rate EF2 the compensation flow occurs through the fourth flow path 31 from the first flow path 16 in the direction of the second flow path 17.

A switching valve 27 is arranged between the third flow path 30 and the fourth flow path 31 within the corresponding section in the second flow path 17. If the electrolysis assembly 10 is operated in parallel flow mode as in FIG. 1, this switching valve is open.

The electrolysis assembly further comprises a water tank 32 by means of which the electrolysis assembly 10 may be supplied with deionized water via a freshwater supply conduit 33. Since the electrolysis reaction in the electrolysis cell stack 11 continuously consumes water this water must be compensated by supplying deionized water. This results in a feed flow 39 with a corresponding feed flow rate FF.

The feed flow rate FF largely corresponds to the amount of water formed in the anode space 11 in the context of the anode half-cell reaction. It is assumed here that only a small amount of water, if any, is discharged from the electrolysis system with the product gases. This is normally the case when water discharged with the product gases is condensed and recycled into the process water system of the electrolysis assembly 10. The required feed flow rate FF may for example be determined from the current density applied to the electrolysis cells since current density and product formation and thus water consumption are correlated.

In the context of the invention it has been found that the permeation flow rate PF may be determined if the compensation flow rate CF and the feed flow rate FF are known. The permeation flow rate PF is derived from the sum of the compensation flow rate CF and the amount (as a flow rate) of water formed at the anode and thus, according to the abovementioned assumptions, the feed flow rate FF. The permeation flow rate PF is accordingly the sum of the compensation flow rate CF and the feed flow rate FF.

The following numerical examples summarized in a table are intended to further elucidate the above correlations.

Parallel flow mode, as shown in FIG. 1

| | | Δp/mbar | | | | | | |
|---|---|---|---|---|---|---|---|---|
| Example | FF/ | (anode to | EF1/ | EF2/ | EF3/ | EF4/ | CF/ | PF/ |
| no. | (kg/h) | cathode) | (kg/h) | (kg/h) | (kg/h) | (kg/h) | (kg/h) | (kg/h) |
| 1 | 12 | 48 | 612 | 988 | 800 | 800 | 188 | 200 |
| 2 | 12 | 12 | 712 | 888 | 800 | 800 | 88 | 100 |
| 3 | 12 | −48 | 1012 | 588 | 800 | 800 | −212 | −200 |

In Examples 1 to 3, the feed flow rate FF of water is relatively low at 12 kg/h. The reason for this is that the electrolysis assembly 10 is operated under partial load. This is always the case when electricity from renewable energy sources is not available in its entirety or not available at all, for example when using electricity from a wind power plant during a lull in wind. To avoid formation of a potentially explosive mixture in partial load operation the electrolysis assembly 10 is operated in parallel flow mode.

The electrolyte flow rates EF3 and EF4 are identical in each case so as to supply the anode space 11 and the cathode space 12 as uniformly as possible. The compensation stream CF derives from the determined electrolyte flow rates EF1 to EF4 established by corresponding control. It has been found that

$$CF = EF 3 - EF 1 and$$

$$CF = EF 2 - EF 4.$$

The permeation flow rate PH may be determined from the known feed flow rate FF and the determined compensation flow rate by the relationship

$$PF = CF + FF .$$

The table shows that in line with expectations the compensation flow rate CF and the permeation flow rate PF increase with increasing pressure difference Δp between the anode space 11 and the cathode space 12.

It has further been found that

$$EF 1 + EF 2 = EF 3 + EF 4$$

and this can be used to run a discrepancy check when performing the control process. In the case of a leak or malfunction of a flowmeter for example the above relationship would no longer hold.

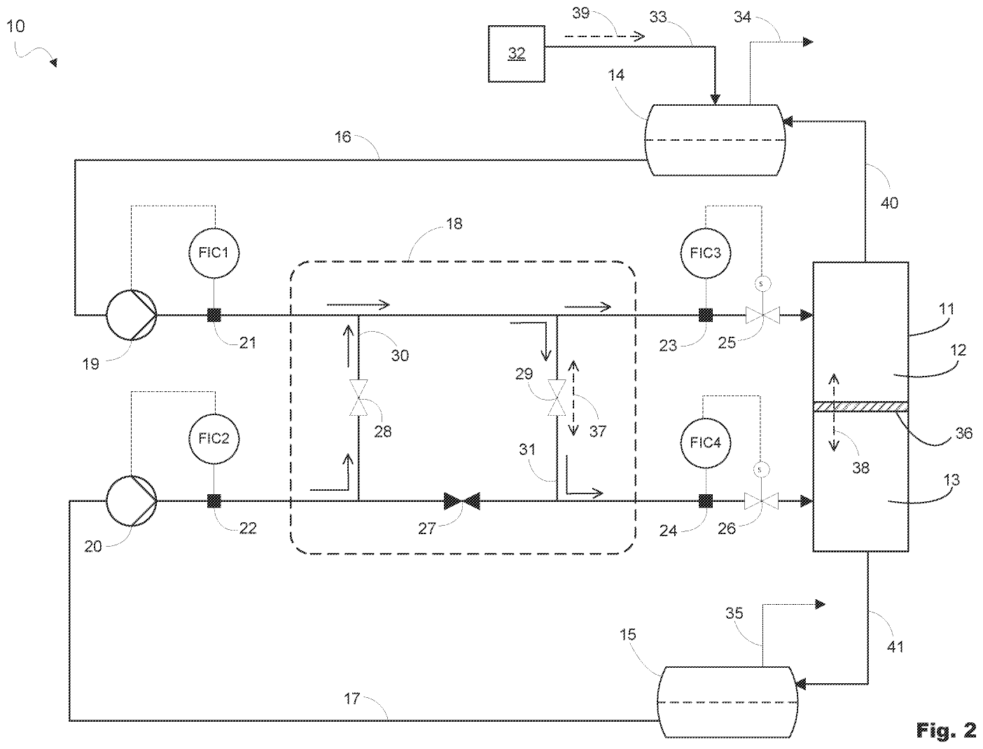

FIG. 2 shows a schematic and highly simplified representation of an electrolysis assembly 10 according to the first embodiment, though in this case configured for performing the process according to the invention in cross flow operation.

Having regard to the arrangement and interconnection of the components the representation according to FIG. 2 does not differ from the representation of FIG. 1. However, in the configuration according to FIG. 2 the switching valve 27 is closed and the switching valve 28 is open. This forces a mixing of the electrolytes from the first flow path 16 and the second flow path 17 corresponding to the flow directions indicated by the arrows. According to the flow rates EF3 and EF4 established and determined via the control valves 25 and 26 the electrolyte stream is subsequently divided between the anode space 11 and the cathode space 12 by means of the fourth flow path 31 (and subsequently the last section of the second flow path 17) and the last section of the first flow path 16.

In the configuration according to FIG. 2 in cross flow operation a concentration compensation between the electrolyte in the first flow path 16 and in the second flow path 17 is effected on account of the mixing of anolyte and catholyte. A compensation flow rate CF may be determined from the electrolyte flow rates EF1 to EF4 on the basis of the abovementioned relationships. The advantage of this determination is inter alia that on this basis and the known feed flow rate FF it allows determination, also for cross flow operation, of the otherwise unknown permeation flow rate PF on account of the relationship

$$PF = CF + FF .$$

The following numerical examples summarized in a table are intended to further elucidate the above correlations.

Cross flow mode, as shown in FIG. 2

| | | Δp/mbar | | | | | | |
|---|---|---|---|---|---|---|---|---|
| Example | FF/ | (anode to | EF1/ | EF2/ | EF3/ | EF4/ | CF/ | PF/ |
| no. | (kg/h) | cathode) | (kg/h) | (kg/h) | (kg/h) | (kg/h) | (kg/h) | (kg/h) |
| 4 | 72 | 48 | 5072 | 5328 | 5200 | 5200 | 128 | 200 |
| 5 | 72 | −48 | 5472 | 4928 | 5200 | 5200 | −272 | −200 |

In Examples 4 and 5, the feed flow rate FF of water at 72 kg/h is markedly higher than in Examples 1 to 3, according to FIG. 1. This is because in this case the electrolysis assembly 10 is operated under higher load or full load. Especially under full load a mixing of the anolyte and catholyte stream is possible or even desired since in this way concentration differences in the electrolysis medium between the anode side and the cathode side are avoided from the start.

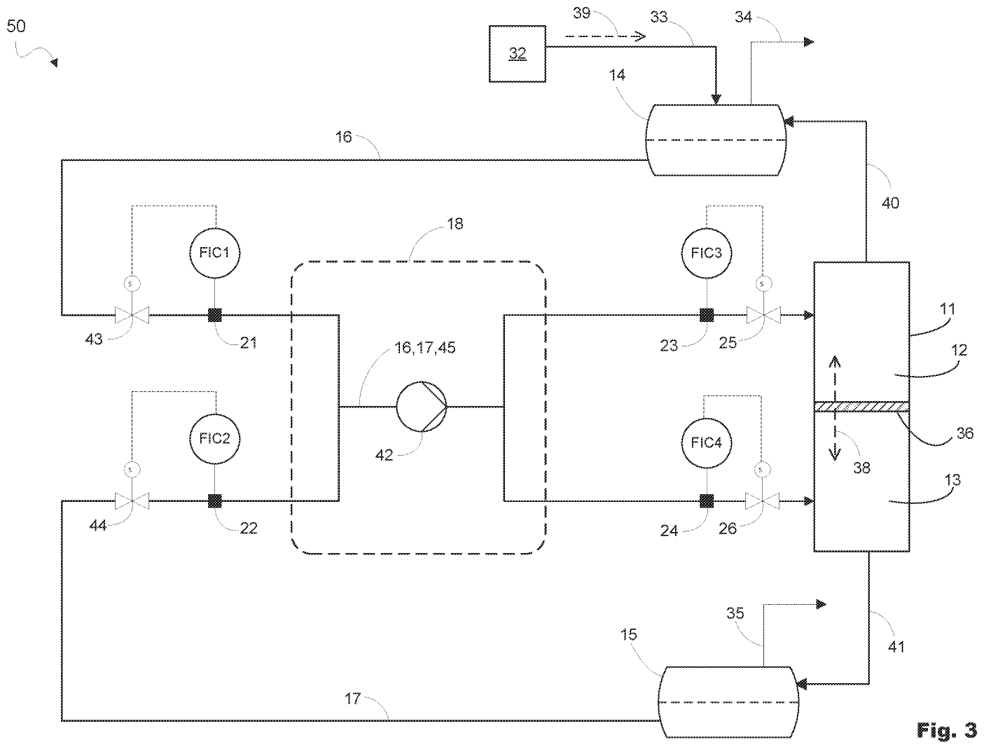

FIG. 3 shows an electrolysis assembly 50 configured exclusively for cross flow operation. Nevertheless the control method according to the invention can also be applied to this case since the permeation flow rate PF of the permeation flow 38 may in turn be determined on the basis of the determinable compensation flow rate CF and the known feed flow rate FF.

In the configuration according to FIG. 3 the electrolysis assembly 50 comprises only a single electrolyte circulation pump 42. The first flow path 16 and the second flow path 17 are configured as a common flow path along a flow path section 45, the electrolyte circulation pump 42 being arranged within this section. Through configuration with the common flow path section 45, the electrolysis assembly 50 may be operated exclusively in cross flow mode, complete mixing of the anolyte and catholyte necessarily being effected in this case.

Four flowmeters 21, 22, 23 and 24 are provided to determine the electrolyte flow rates EF1, EF2, EF3 and EF4. Four control valves 43, 44, 25 and 26 which are in operative connection with the respective flowmeters are provided to control the electrolyte flows. The determined electrolyte flow rates EF1 to EF4 may be used to determine a non-zero compensation flow rate, for example when the values of EF1 and EF3 and/or of EF2 and EF4 differ from one another. The compensation flow rate CF and the known feed flow rate FF of the feed flow 39 may in turn be used to determine the permeation flow rate PF of the permeation flow 38.

### LIST OF REFERENCE SYMBOLS

10, 50 Electrolysis assembly
11 Electrolysis cell stack
12 Anode space
13 Cathode space
14 Anode-side gas-liquid separator
15 Cathode-side gas-liquid separator
16 First flow path
17 Second flow path
18 Compensation system
19, 20, 42 Electrolyte circulation pump
21 Flowmeter for electrolyte flow rate EF1
22 Flowmeter for electrolyte flow rate EF2
23 Flowmeter for electrolyte flow rate EF3
24 Flowmeter for electrolyte flow rate EF4
25, 26, 43, 44 Control valve
27, 28, 29 Switching valve
30 Third flow path
31 Fourth flow path
32 Water tank
33 Fresh water supply conduit
34 Oxygen product conduit
35 Hydrogen product conduit
36 Diaphragm (separator)
37 Compensation flow
38 Permeation flow
39 Feed flow
40 First connecting conduit
41 Second connecting conduit
45 Flow path section

What is claimed is:

1. A process for controlling an electrolyzer for production of hydrogen, wherein the electrolyzer is operated with an electrolyte having an electrolyte concentration, wherein
the electrolyzer comprises an electrolysis cell stack having an anode space and a cathode space and
an anode-side and a cathode-side gas-liquid separator, wherein
the anode space and the anode-side gas-liquid separator are fluidically connected to one another via a first flow path and
the cathode space and the cathode-side gas-liquid separator are fluidically connected to one another via a second flow path and
the electrolyzer comprises a compensation system arranged downstream of the gas-liquid separator and upstream of the electrolysis cell stack which establishes a fluidic connection between the first and the second flow path and is configured such that an at least partial concentration compensation between an electrolyte concentration in the first flow path and an electrolyte concentration in the second flow path is achievable and wherein the process comprises the following process steps:
a) establishing a differential pressure Δp between the anode space and the cathode space;
b) determining
i. a first electrolyte flow rate EF1 within the first flow path and upstream of the compensation system,
ii. a second electrolyte flow rate EF2 within the second flow path and upstream of the compensation system,
iii. a third electrolyte flow rate EF3 within the first flow path and downstream of the compensation system and
iv. a fourth electrolyte flow rate EF4 within the second flow path and downstream of the compensation system;
c) determining a compensation flow rate CF from the abovementioned electrolyte flow rates, wherein the compensation flow rate CF corresponds to the net flow rate via the compensation system between the first flow path and the second flow path.

2. The process according to claim 1, wherein CF=EF3−EF1 and CF=EF2−EF4.

3. The process according to claim 1, further comprising the further process steps:
d) determining a feed flow rate FF, wherein the feed flow rate FF corresponds to the amount of water supplied to the electrolyzer per unit time and consumed per unit time by a hydrogen formation reaction and an oxygen formation reaction;
e) determining a permeation flow rate PF from the feed flow rate FF and the compensation flow rate CF, wherein the permeation flow rate PF corresponds to the flow rate through all separators (36) arranged between the cathode space and the anode space.

4. The process according to claim 3, wherein PF=CF+FF.

5. The process according to claim 1, wherein the third electrolyte flow rate EF3 and the fourth electrolyte flow rate EF4 are adjusted such that EF3=EF4.

6. The process according to claim 1, wherein the liquid level in each of the gas-liquid separators is controlled such that it assumes a constant value over time.

7. The process according to claim 1, wherein the differential pressure Δp is adjusted according to the utilization of the electrolyzer.

8. The process according to claim 1, wherein the electrolyzer is operated in parallel flow mode, wherein electrolyte withdrawn from the anode-side gas-liquid separator is supplied to the anode space and electrolyte withdrawn from the cathode-side gas-liquid separator is supplied to the cathode space and wherein the compensation system at least partially effects concentration compensation between the electrolyte concentration in the first flow path and the electrolyte concentration in the second flow path.

9. The process according to claim 1, wherein the electrolyzer is operated in cross flow mode, wherein the electrolyte withdrawn from the anode-side gas-liquid separator and the electrolyte withdrawn from the cathode-side gas-liquid separator are completely mixed and subsequently the resulting mixed electrolyte stream is separated into two substreams and the substreams are supplied to the cathode space and the anode space.

10. The process according to claim 1, wherein the compensation system
comprises a third flow path which effects fluidic connection of the first flow path and the second flow path to one another, wherein the third flow path is arranged downstream of the positions at which determination of the first electrolyte flow rate EF1 within the first flow path and determination of the second electrolyte flow rate EF2 within the second flow path are effected and
comprises a fourth flow path which effects fluidic connection of the first flow path and the second flow path to one another, wherein the fourth flow path is arranged downstream of the third flow path and upstream of the positions at which determination of the third electrolyte flow rate EF3 within the first flow path and determination of the fourth electrolyte flow rate EF4 within the second flow path are effected.

11. The process according to claim 10, wherein a first valve is arranged within the third flow path and a second valve is arranged within the fourth flow path and a third valve is arranged within the first flow path or within the second flow path downstream of the third flow path and upstream of the fourth flow path.

12. The process according to claim 1, wherein a first electrolyte circulation pump is arranged within the first flow path and a second electrolyte circulation pump is arranged within the second flow path.

13. The process according to claim 1, wherein the compensation system is configured such that the first flow path and the second flow path are configured as a common flow path along a flow path section, wherein the flow path section is arranged downstream of the positions at which determination of the first electrolyte flow rate EF1 within the first flow path and determination of the second electrolyte flow rate EF2 within the second flow path are effected and the flow path section is arranged upstream of the positions at which determination of the third electrolyte flow rate EF3 within the first flow path and determination of the fourth electrolyte flow rate EF4 within the second flow path are effected.

14. The process according to claim 13, wherein an electrolyte circulation pump is arranged within the flow path section.
